(19) United States
(12) Patent Application Publication
(10) Pub. No.: US 2026/0113523 A1
(43) Pub. Date: Apr. 23, 2026

(54) Optical Imaging Module

(71) Applicant: AAC Optics (Nanning) Co., Ltd., Nanning (CN)

(72) Inventors: Xingze Zhang, Nanning (CN); Liang Li, Nanning (CN); Yong Xiong, Nanning (CN)

(21) Appl. No.: 19/002,802

(22) Filed: Dec. 27, 2024

Related U.S. Application Data
(63) Continuation of application No. PCT/CN2024/126250, filed on Oct. 22, 2024.

(51) Int. Cl. H04N 23/54; H04N 23/58

(52) U.S. Cl. CPC H04N 23/54; H04N 23/58

(57) ABSTRACT

An optical imaging module includes an image sensor assembly which includes an image sensor having a central axis, a movable support, a fixation support, at least one guide rail on the movable support, and at least one ball bearing in one-to-one correspondence to the at least one guide rail. Each guide rail has a first end and a second end closer to the central axis than the first end, and obliquely extends from the first end to the second end along a direction close to the central axis and the fixation support. Each ball bearing is sandwiched between the corresponding guide rail and the fixation support. A height of the movable support relative to the fixation support along the central axis at each guide rail changes with a displacement of the corresponding ball bearing in its guide rail. The optical imaging module has a simple overall structure.

### FIELD OF THE PRESENT DISCLOSURE

The present disclosure relates to the optical imaging field, in particular to an optical imaging module.

### DESCRIPTION OF THE RELATED ART

An optical imaging module in the related art needs a voice coil motor to drive an image sensor thereof to perform focusing movement and tilt compensation.

The voice coil motor includes a coil and a magnet. The image sensor is driven by electromagnetic force between the coil and the magnet to perform focusing movement and tilt compensation.

However, the coil and the magnet need a complex structure and a sufficient space to match them, furthermore, a guide support must be provided to guide and support the image sensor to perform focusing movement and tilt compensation. As a result, the optical imaging module has a complex overall structure.

Thus, it is necessary to provide a novel optical imaging module to solve the problems.

### SUMMARY

An objective of the present disclosure is to overcome the above problems and provide an optical imaging module which can realize focusing movement and tilt compensation of the image sensor and has a simple overall structure.

In order to achieve the objective mentioned above, the present disclosure discloses an optical imaging module including a lens assembly having an optical axis and an image sensor assembly arranged on an image side of the lens assembly. The image sensor assembly includes an image sensor having a central axis, a movable support holding the image sensor, a fixation support arranged on a side of the movable support away from the lens assembly, at least one guide rail, and at least one ball bearing. The at least one guide rail is obliquely arranged on a surface of the movable support facing the fixation support. Each guide rail has a first end and a second end, and the second end is closer to the central axis of the image sensor than the first end. Each guide rail obliquely extends from the first end to the second end along a direction close to the central axis of the image sensor and close to the fixation support. The at least one ball bearing is in one-to-one correspondence to the at least one guide rail, and each ball bearing is sandwiched between the corresponding guide rail and the fixation support. A height of the movable support relative to the fixation support along the central axis of the image sensor at each guide rail changes with a displacement of the corresponding ball bearing in its guide rail.

As an improvement, each ball bearing is magnetic. An initial position of each ball bearing is at the first end of the corresponding guide rail. The image sensor assembly further includes at least one coil in one-to-one correspondence to the at least one ball bearing. Each ball bearing is pushed to move from the first end towards the second end in the corresponding guide rail when the corresponding coil is energized.

As an improvement, the movable support has a quadrilateral shape with four edges. An amount of the guide rails is four, and the four guide rails are arranged on the four edges of the movable support in one-to-one correspondence. Each guide rail is arranged at a middle position of the corresponding edge of the movable support.

As an improvement, the central axis of the image sensor coincides with the optical axis of the lens assembly.

As an improvement, the optical imaging module further includes a shell. The shell includes an upper shell and a bottom shell engaged with the upper shell. The lens assembly is arranged in the upper shell, and the image sensor assembly is arranged in the bottom shell. A bottom wall of the bottom shell acts as the fixation support.

As an improvement, the movable support is a circuit board, and the image sensor is electrically connected with the circuit board.

In the optical imaging module according to the present disclosure, the at least one guide rail is obliquely arranged on the surface of the movable support facing the fixation support. Each guide rail obliquely extends from the first end to the second end along a direction close to the central axis of the image sensor and close to the fixation support. The at least one ball bearing is in one-to-one correspondence to the at least one guide rail, and each ball bearing is sandwiched between the corresponding guide rail and the fixation support. The height of the movable support relative to the fixation support along the central axis of the image sensor at each guide rail changes with the displacement of the corresponding ball bearing in its guide rail. When there is only one guide rail, or the changed heights at the two or more guide rails are the same, the image sensor can perform focusing movement. When the changed heights at the two or more guide rails are different, the central axis of the image sensor can tilt in different directions and at different angles, the image sensor can perform tilt compensation. In addition, the focusing movement and/or tilt compensation of the image sensor can be realized by the at least one guide rail obliquely arranged on the movable support and the displacement of the corresponding ball bearing in its guide rail, thus, the optical imaging module has a simple overall structure.

### BRIEF DESCRIPTION OF THE DRAWINGS

In order to more clearly illustrate the technical solutions in embodiments of the present disclosure, the accompanying drawings used in the description of the embodiments will be briefly introduced below. It is apparent that, the accompanying drawings in the following description are only some embodiments of the present disclosure, and other drawings can be obtained by those of ordinary skill in the art based on the accompanying drawings without creative efforts, wherein:

FIG. 1 is an exploded view of an optical imaging module of the present disclosure.

FIG. 2 is a cross-sectional view of the optical imaging module of the present disclosure.

FIG. 3 is an isometric view of an assembly of a movable support and guide rails of the optical imaging module of the present disclosure.

### DETAILED DESCRIPTION OF THE EMBODIMENTS

The technical solutions in embodiments of the present disclosure will be described clearly and completely below with reference to the accompanying drawings in the embodiments of the present disclosure. It is apparent that, the described embodiments are merely some of rather than all of the embodiments of the present disclosure. All other embodiments acquired by those of ordinary skill in the art without creative efforts based on the embodiments of the present disclosure shall fall within the protection scope of the present disclosure.

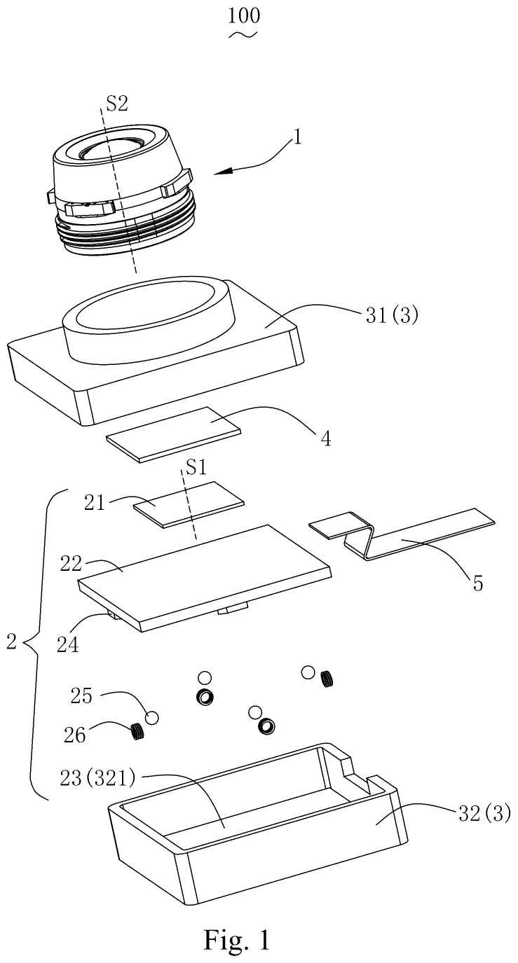

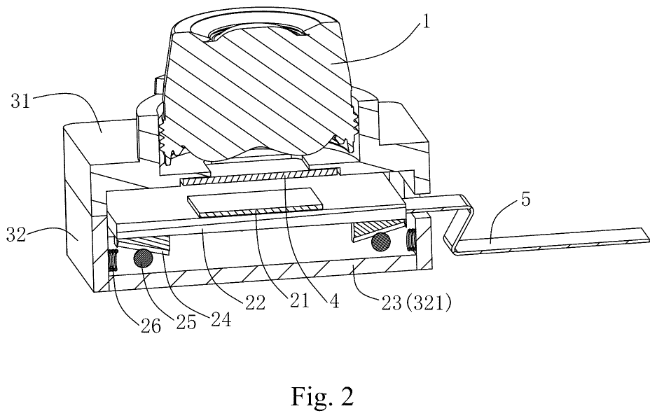

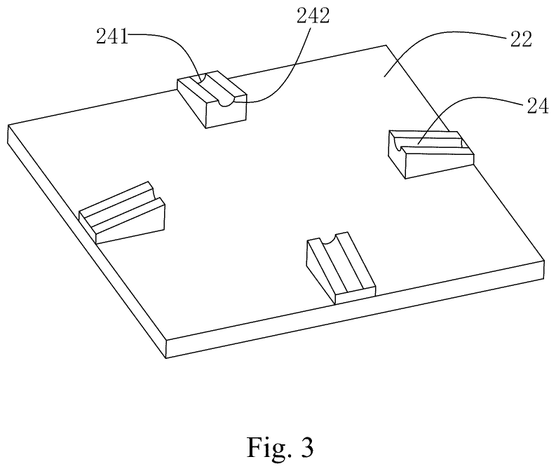

Referring to FIGS. 1-3, the present disclosure discloses an optical imaging module 100 including a lens assembly 1 having an optical axis S2 and an image sensor assembly 2 arranged on an image side of the lens assembly 1.

The image sensor assembly 2 includes an image sensor 21 having a central axis S1, a movable support 22 holding the image sensor 21, a fixation support 23 arranged on a side of the movable support 22 away from the lens assembly 1, at least one guide rail 24, and at least one ball bearing 25. The at least one guide rail 24 is obliquely arranged on a surface of the movable support 22 facing the fixation support 23. Each guide rail 24 has a first end 241 and a second end 242, and the second end 242 is closer to the central axis S1 of the image sensor 21 than the first end 241. Each guide rail 24 obliquely extends from the first end 241 to the second end 242 along a direction close to the central axis S1 of the image sensor 21 and close to the fixation support 23. The at least one ball bearing 25 is in one-to-one correspondence to the at least one guide rail 24, and each ball bearing 25 is sandwiched between the corresponding guide rail 24 and the fixation support 23. A height of the movable support 22 relative to the fixation support 23 along the central axis S1 of the image sensor 21 at each guide rail 24 changes with a displacement of the corresponding ball bearing 25 in its guide rail 24.

Optionally, each ball bearing 25 may be magnetic. An initial position of each ball bearing 25 is at the first end 241 of the corresponding guide rail 24. The image sensor assembly 2 further includes at least one coil 26 in one-to-one correspondence to the at least one ball bearing 25. Each ball bearing 25 is pushed to move from the first end 241 towards the second end 242 in the corresponding guide rail 24 when the corresponding coil 26 is energized. In other embodiments, the ball bearing 25 may also be not magnetic, and the driver is not the energized coil 26, instead, any way can drive the ball bearing 25 to move is possible.

Optionally, the movable support 22 has a quadrilateral shape with four edges. An amount of the guide rails 24 is four, and the four guide rails 24 are arranged on the four edges of the movable support 22 in one-to-one correspondence. Each guide rail 24 is arranged at a middle position of the corresponding edge of the movable support 22. In other embodiments, the movable support 22 may have other shapes as desired, and the amount of the guide rails 24 may be other numbers as desired.

Optionally, the central axis S1 of the image sensor 21 coincides with the optical axis S2 of the lens assembly 1.

Optionally, the optical imaging module 100 further includes a shell 3. The shell 3 includes an upper shell 31 and a bottom shell 32 engaged with the upper shell 31. The lens assembly 1 is arranged in the upper shell 31, and the image sensor assembly 2 is arranged in the bottom shell 32. A bottom wall 321 of the bottom shell 32 acts as the fixation support 23, in other embodiments, the fixation support 23 may be formed in other ways as desired. The optical imaging module 100 further includes an optical filter 4 arranged in the upper shell 31 and between the lens assembly 1 and the image sensor assembly 2.

Optionally, the movable support 22 is a circuit board, and the image sensor 21 is electrically connected with the circuit board. The optical imaging module 100 further includes a flexible circuit board 5 connected with the movable support 22 and extending outside the shell 3. The flexible circuit board 5 can be used to transmit an electrical signal of the image sensor 21 and to supply power to the coil 26.

In the optical imaging module 100 according to the present disclosure, the at least one guide rail 24 is obliquely arranged on the surface of the movable support 22 facing the fixation support 23. Each guide rail 24 obliquely extends from the first end 241 to the second end 242 along a direction close to the central axis S1 of the image sensor 21 and close to the fixation support 23. The at least one ball bearing 25 is in one-to-one correspondence to the at least one guide rail 24, and each ball bearing 25 is sandwiched between the corresponding guide rail 24 and the fixation support 23. The height of the movable support 22 relative to the fixation support 23 along the central axis S1 of the image sensor 21 at each guide rail 24 changes with the displacement of the corresponding ball bearing 25 in its guide rail 24. When there is only one guide rail 24, or the changed heights at the two or more guide rails 24 are the same, the image sensor 21 can perform focusing movement. When the changed heights at the two or more guide rails 24 are different, the central axis S1 of the image sensor 21 can tilt in different directions and at different angles, the image sensor 21 can perform tilt compensation. In addition, the focusing movement and/or tilt compensation of the image sensor 21 can be realized by the at least one guide rail 24 obliquely arranged on the movable support 22 and the displacement of the corresponding ball bearing 25 in its guide rail 24, thus, the optical imaging module 100 has a simple overall structure.

The above are only embodiments of the present disclosure. It should be pointed out that those of ordinary skill in the art may also make improvements without departing from the ideas of the present disclosure, all of which fall within the protection scope of the present disclosure.

What is claimed is:

1. An optical imaging module, comprising:
a lens assembly having an optical axis; and
an image sensor assembly arranged on an image side of the lens assembly, comprising an image sensor having a central axis, a movable support holding the image sensor, a fixation support arranged on a side of the movable support away from the lens assembly, at least one guide rail, and at least one ball bearing,
wherein the at least one guide rail is obliquely arranged on a surface of the movable support facing the fixation support, each guide rail has a first end and a second end, the second end is closer to the central axis of the image sensor than the first end, each guide rail obliquely extends from the first end to the second end along a direction close to the central axis of the image sensor and close to the fixation support, the at least one ball bearing is in one-to-one correspondence to the at least one guide rail, each ball bearing is sandwiched between the corresponding guide rail and the fixation support, a height of the movable support relative to the fixation support along the central axis of the image sensor at each guide rail changes with a displacement of the corresponding ball bearing in its guide rail.

2. The optical imaging module as described in claim 1, wherein each ball bearing is magnetic, an initial position of each ball bearing is at the first end of the corresponding guide rail, the image sensor assembly further comprises at least one coil in one-to-one correspondence to the at least one ball bearing, each ball bearing is pushed to move from the first end towards the second end in the corresponding guide rail when the corresponding coil is energized.

3. The optical imaging module as described in claim 1, wherein the movable support has a quadrilateral shape with four edges, an amount of the guide rails is four, the four guide rails are arranged on the four edges of the movable support in one-to-one correspondence, each guide rail is arranged at a middle position of the corresponding edge of the movable support.

4. The optical imaging module as described in claim 1, wherein the central axis of the image sensor coincides with the optical axis of the lens assembly.

5. The optical imaging module as described in claim 1 further comprising a shell, wherein the shell comprises an upper shell and a bottom shell engaged with the upper shell, the lens assembly is arranged in the upper shell, the image sensor assembly is arranged in the bottom shell, a bottom wall of the bottom shell acts as the fixation support.

6. The optical imaging module as described in claim 1, wherein the movable support is a circuit board, the image sensor is electrically connected with the circuit board.
